(19) United States
(12) Patent Application Publication
(10) Pub. No.: US 2006/0162351 A1
(43) Pub. Date: Jul. 27, 2006

(54) Vehicle air-conditioning unit with an electronic control device

(76) Inventor: Mohamed Ben Yahia, Paris (FR)

Correspondence Address: Liniak Berenato Longacre & White, Suite 240, 6550 Rock Spring Drive, Bethesda, MD, 20817, US

(21) Appl. No.: 10/515,706

(22) PCT Filed: May 23, 2003
(86) PCT No.: PCT/FR03/01561

§ 371 Date: Nov. 23, 2004

(30) Foreign Application Priority Data
May 31, 2002 (FR) 02/06724

(51) Int. Cl. G01K 13/00

(52) U.S. Cl. 62/129

(57) ABSTRACT

The invention proposes an air conditioning installation having both an air conditioning apparatus and an electronic printed circuit. The installation also includes measuring means which are adapted to transmit values to the electronic circuit for estimation of a first value relating to the temperature (Tin) of the liquid at the input to the expansion unit, a second value relating to the inlet pressure (Pin) of the expansion unit, and a third value relating to the outlet pressure (Pout) of the expansion unit. The electronic circuit is adapted to calculate the value of the mass flow (MOT) of the refrigerant fluid into the expansion unit from the estimate of the first, second and third values. From this value of the mass flow (MOT) of the refrigerant fluid into the expansion unit and the estimate of the third value (Pout), the electronic circuit is able to estimate the power absorbed by the compressor.

This invention relates to air conditioning installations for motor vehicles.

In conventional motor vehicles, the compressor of the air conditioning circuit is driven by the engine and therefore consumes some of the power from the engine. Although the power absorbed by the compressor, when it is running, is not great, it does nevertheless affect the output of the engine. By reducing the engine output, the power actually absorbed by the compressor increases fuel consumption and increases the pollution produced by the exhaust gases from the vehicle.

In order to optimise the engine output, one solution consists in estimating the instantaneous power actually absorbed by the compressor. Knowledge of this information then enables the injection parameters of the engine to be adapted to actual needs. In the absence of this information, the injection computer will by default choose injection parameters that correspond to the maximum value of the power absorbed, even though this value is rarely attained in practice.

This disadvantage can apply to mechanical compressors with internal control, which function through the clutch interposed between the engine and the compressor. In regulated mode, compressors with internal control adapt their output in accordance with a linear law which links the value of the inlet pressure of the condenser, referred to as low pressure, with its value at the compressor outlet, referred to as the high pressure. Nevertheless, it does happen that the power actually absorbed by the compressor is less than its nominal power.

Such compressors absorb a power which depends on the working conditions, and which can therefore not be reduced even if the power actually absorbed by the compressor is known. On the other hand, it is possible to regulate the operation of the air conditioning system by declutching the compressor when the power is not acceptable.

This disadvantage is even worse for compressors with external control, the use of which is becoming general.

In this connection, in mechanical compressors with external control, the power actually absorbed by the compressor is often less than its nominal power. As a result, the injection system must compensate for the difference between the nominal mechanical pressure and the mechanical pressure actually absorbed, and this reduces the output of the engine.

In known embodiments, estimation of the instantaneous power absorbed by the compressor is obtained from a diagram of the operating states most used. Estimation of the power absorbed by the compressor is achieved by comparing the operating state of the air conditioning circuit with a reference state which is part of the diagram, by using the instantaneous value of the high pressure measured by a first sensor and an item of information relating to the operation of the vehicle, measured by a second sensor. Methods based on such a diagram require long development times, and are empirical. In particular, they have the disadvantage that they do not have any regard to all the situations which are possible in operation, and are therefore approximate.

Some versions do exist which are based on the operating state of the air conditioning circuit, for estimating the power absorbed by the compressor. On the other hand, they do not take into account the particular operating mode of the expansion unit.

An object of the present invention is to propose an apparatus which is adapted to supply an estimate of the power absorbed by the compressor from an estimate of the mass flow of the refrigerant fluid which has been expanded in an expansion unit.

A further object of the present invention is to propose such a device which is capable of estimating the mass flow of the refrigerant fluid, expanded in the expansion unit, from the operating mode of the expansion unit.

To this end, the invention proposes an air conditioning installation for a motor vehicle having an injection computer and an air conditioning regulator, the installation comprising a refrigerant circuit including a compressor, a cooling unit, an expansion unit and an evaporator, together with an electronic control device which is adapted to interact with the refrigerant fluid circuit, the injection computer and the air conditioning regulator.

The installation advantageously includes measuring devices adapted to transmit values to the electronic control device for estimation of:

a first value relating to the temperature of the refrigerant fluid at the inlet of the expansion unit,

a second value relating to the pressure of the refrigerant fluid at the inlet of the expansion unit, and

a third value relating to the pressure of the refrigerant fluid at the outlet of the expansion unit,

and the electronic control device is adapted to calculate the value of the mass flow of the refrigerant fluid in the expansion unit from the estimation of the said first, second and third values, and to estimate, from the said value of the mass flow of the refrigerant fluid in the expansion unit, and from the estimation of the third value, the power absorbed by the compressor.

In a first embodiment, the expansion unit is an orifice with a fixed cross section, and the cooling unit is a condenser.

In a second embodiment, the installation includes an internal heat exchanger, and the expansion unit is an orifice of variable cross section and the refrigerant fluid is supercritical.

In a modified version of the second embodiment, the expansion unit is an electrical valve, and the mass flow of the refrigerant fluid is further estimated from the value of the intensity of the current supplied to the electrical valve by the air conditioning regulator.

According to one feature of the invention, the first value is measured by a measuring means located at the inlet of the expansion unit.

According to another feature of the invention, the second value is measured by a measuring means located at the inlet of the expansion unit.

In a modified version of the first embodiment, the electronic control device is adapted to calculate an estimate of the first value from information relating to the operation of the vehicle transmitted by the injection computer, and from the second value.

In particular, the said information relating to the operation of the vehicle consists of the forward speed of the vehicle, the voltage in the motorised fan unit of the air conditioning circuit, and the temperature of the flow of air from outside.

According to a feature of the second embodiment, the installation includes a first measuring means adapted to supply a value relating to the temperature at the outlet of the cooling unit.

According to a further feature of the invention, the installation includes a second measuring means adapted to supply a value relating to the evaporation temperature.

In particular, the second measuring means is a sensor, which is located between the fins of the evaporator and which provides a measurement of the instantaneous value of the evaporation temperature.

In a modified version, the electronic control device is adapted to estimate the value of the evaporation temperature from the instantaneous value of the temperature of blown air at the outlet of the evaporator supplied by the cabin regulator.

In the second embodiment, the electronic control device is adapted to calculate an estimate of the first value from the values supplied by the first and second measuring means.

In a preferred embodiment of the invention, the electronic control device is adapted to estimate the third value from the value supplied by the second measuring means.

In a first modified version of the invention, the compressor is a compressor with external control, having a control valve, while the electronic control device is adapted to calculate a first estimate of the third value from previously registered values of the aspiration pressure of the compressor, the second value and the value of the intensity of the current transmitted by the injection computer to the control valve of the compressor.

In a second modified version, the compressor is a compressor with internal control, while the electronic control device is adapted to calculate a first estimate of the third value from the previously entered values of the aspiration pressure of the compressor, and from the second value.

In a third modified version, the compressor is a fixed load compressor, while the electronic control device is adapted to calculate a first estimate of the third value from the values, previously entered, of the aspiration pressure of the compressor, and from the second value.

In one of these three modified versions, the electronic control device is adapted to supply an estimate of the mass flow of the compressor at full power from the second and third values.

In a complementary arrangement, the electronic control device is adapted to adjust the first estimate of the third value by comparing the estimated mass flow of the refrigerant fluid into the expansion unit with the mass flow of the compressor at full power.

Preferably, the electronic control device is adapted to adjust the first estimate of the third value by a correction factor, when the mass flow of the refrigerant fluid into the expansion unit is greater than the mass flow of the compressor at full power.

In particular, the correction factor relates to the ratio between the mass flow of the refrigerant fluid into the expansion unit and the mass flow of the compressor at full power.

According to yet another feature of the invention, the third value is supplied by a measuring means located at the inlet of the compressor.

According to the second embodiment, the power absorbed by the compressor is further estimated from the value relating to the temperature at the outlet of the cooling unit.

The invention also covers a product programme which can be defined as comprising the functions which are employed in order to estimate the power absorbed by the compressor.

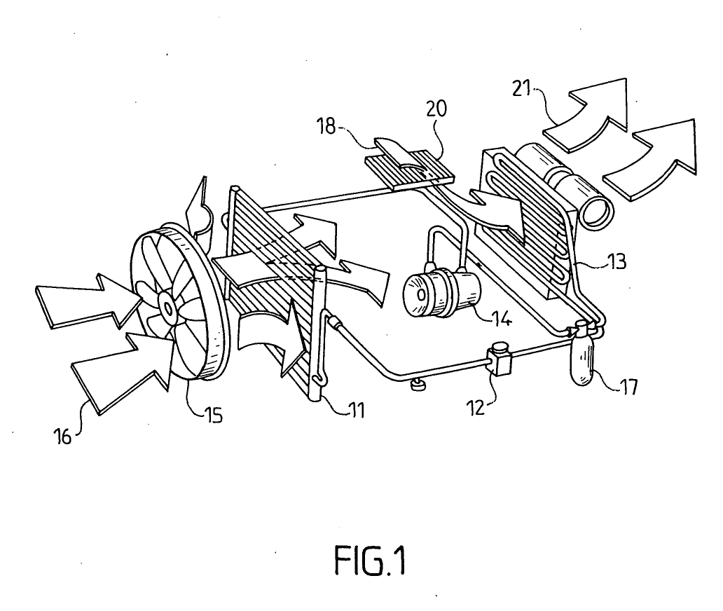

FIG. 1 shows one example of an assembled view of an air conditioning apparatus installed on board a vehicle,

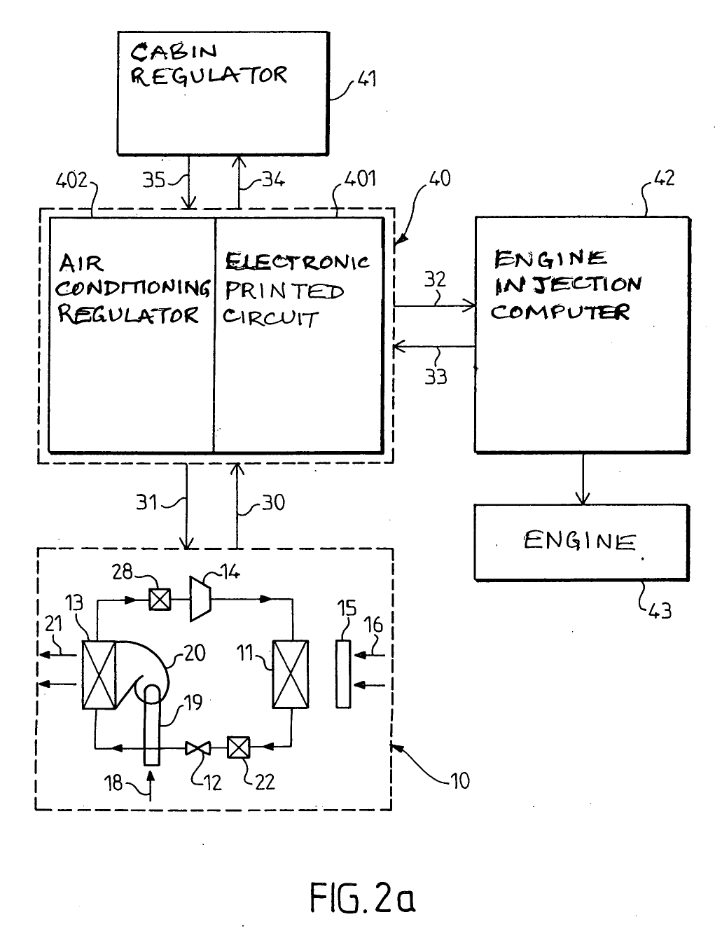

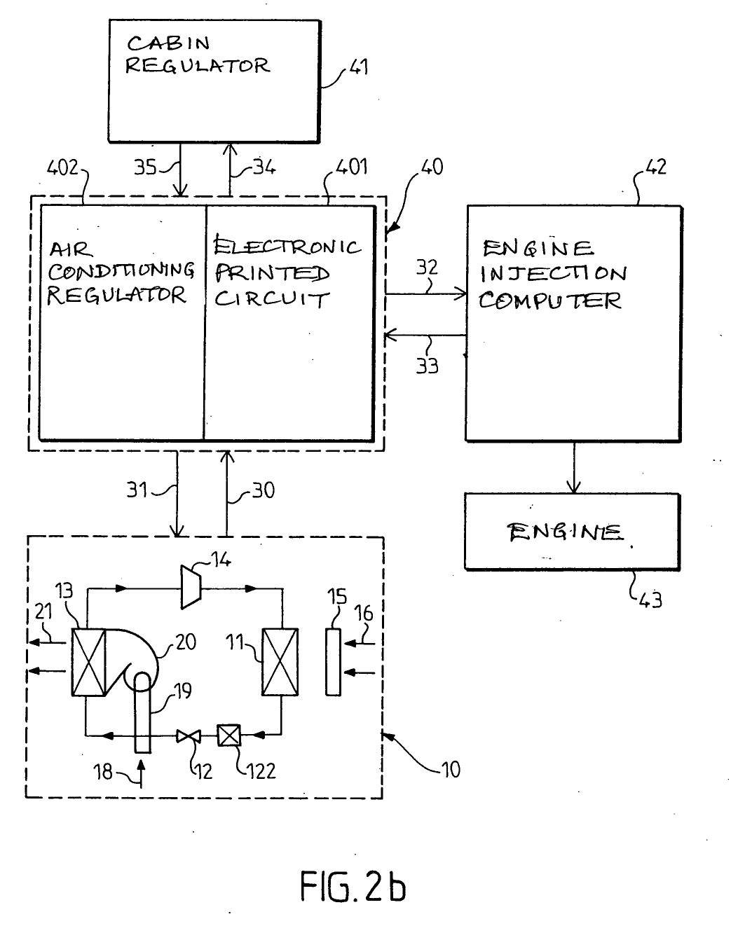

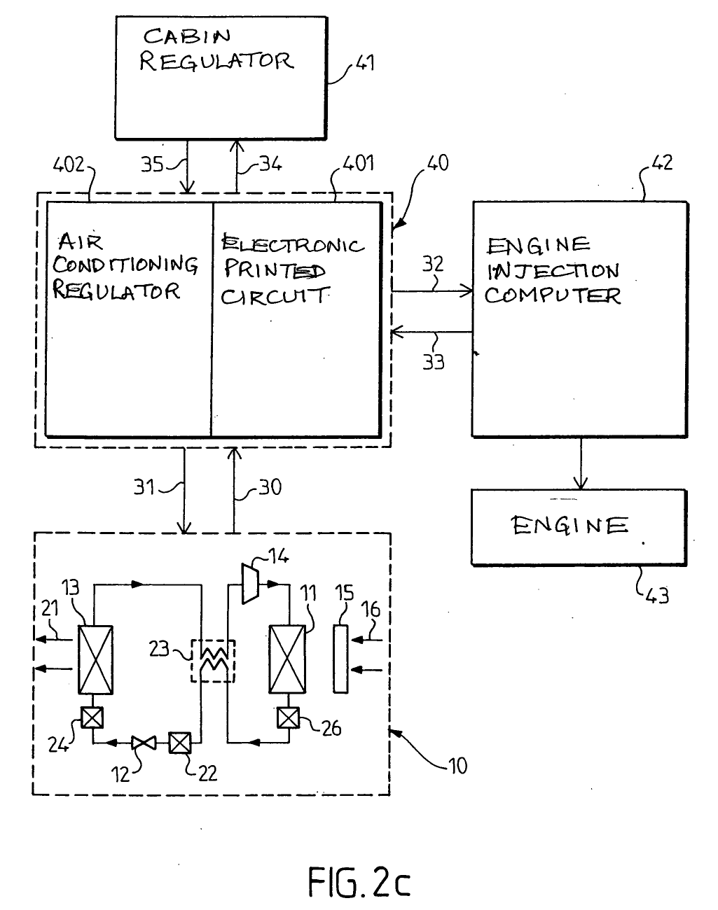

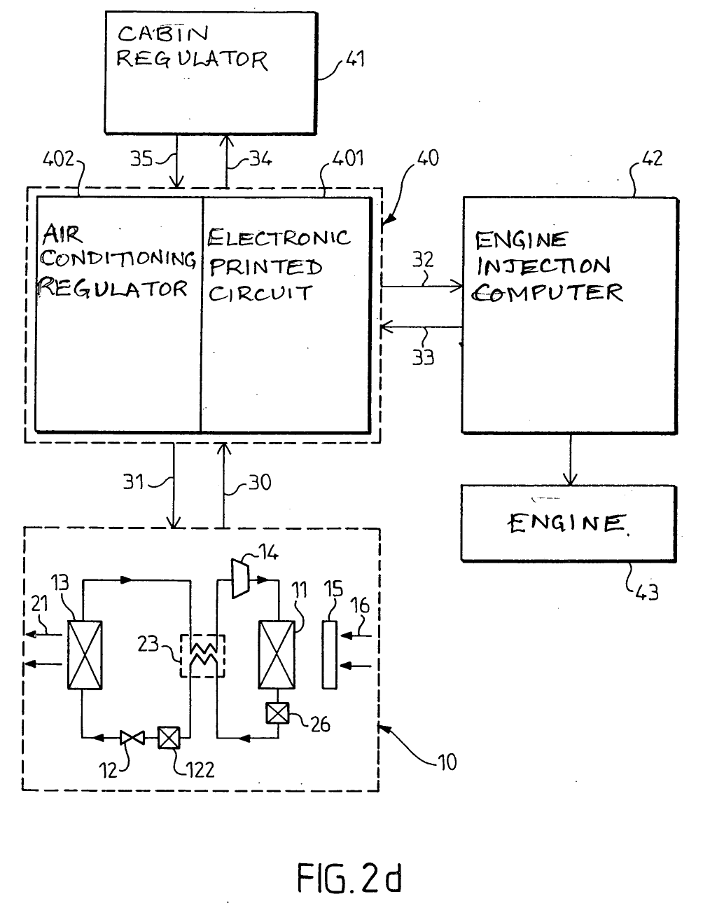

FIGS. 2a and 2b are diagrams of an automobile or motor vehicle having a control apparatus, in a first embodiment of the invention,

FIGS. 2c and 2d are diagrams of an installation in a motor vehicle or automobile, having the control apparatus in accordance with a second embodiment of the invention,

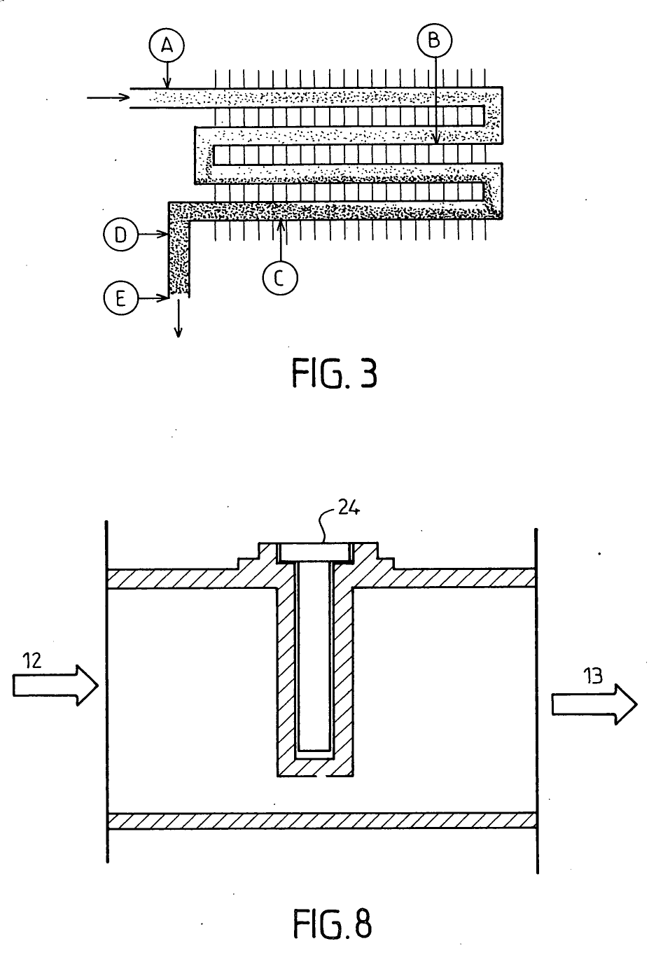

FIG. 3 illustrates the operation of a condenser,

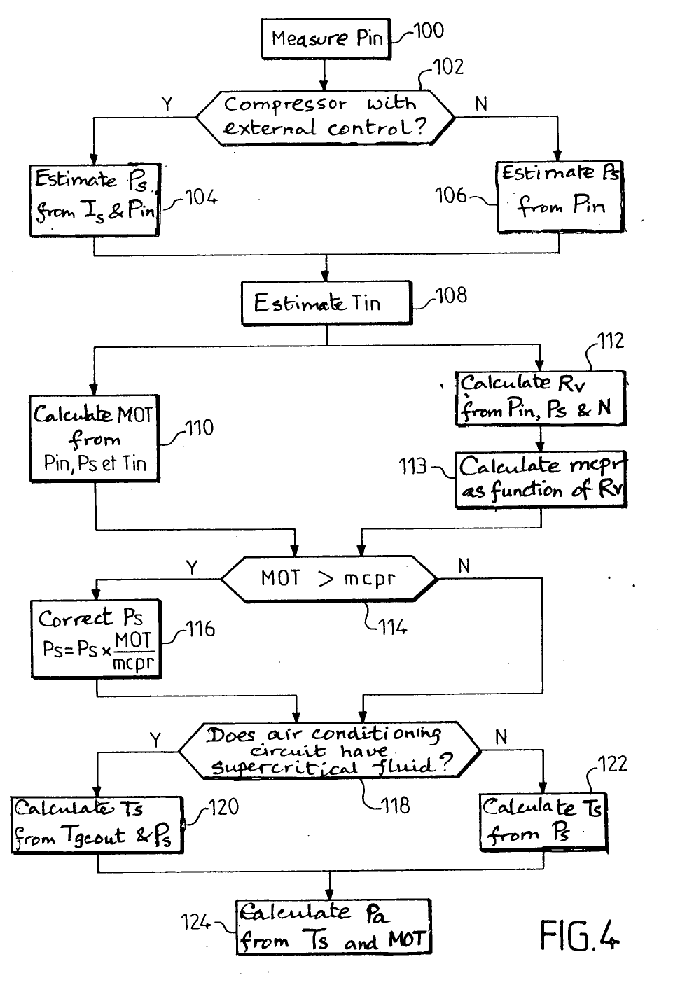

FIG. 4 is a process diagram illustrating the various steps carried out by the installation in accordance with the invention, in one particular embodiment,

FIG. 5 is a diagram showing the curve of regulation for a compressor with external control,

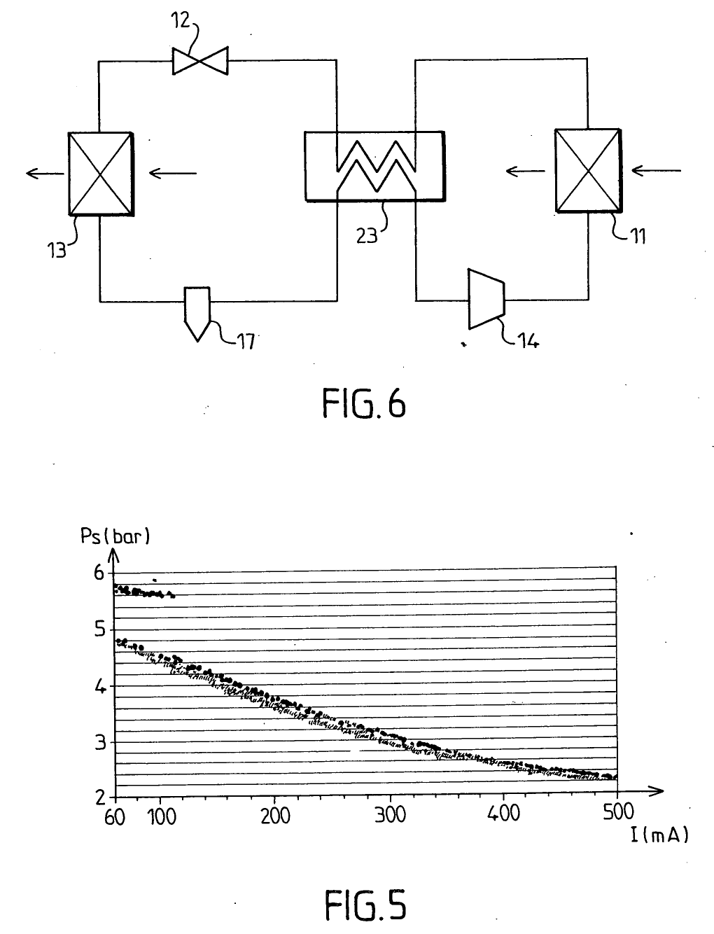

FIG. 6 is a diagram of an installation for an automobile or motor vehicle, in the second embodiment,

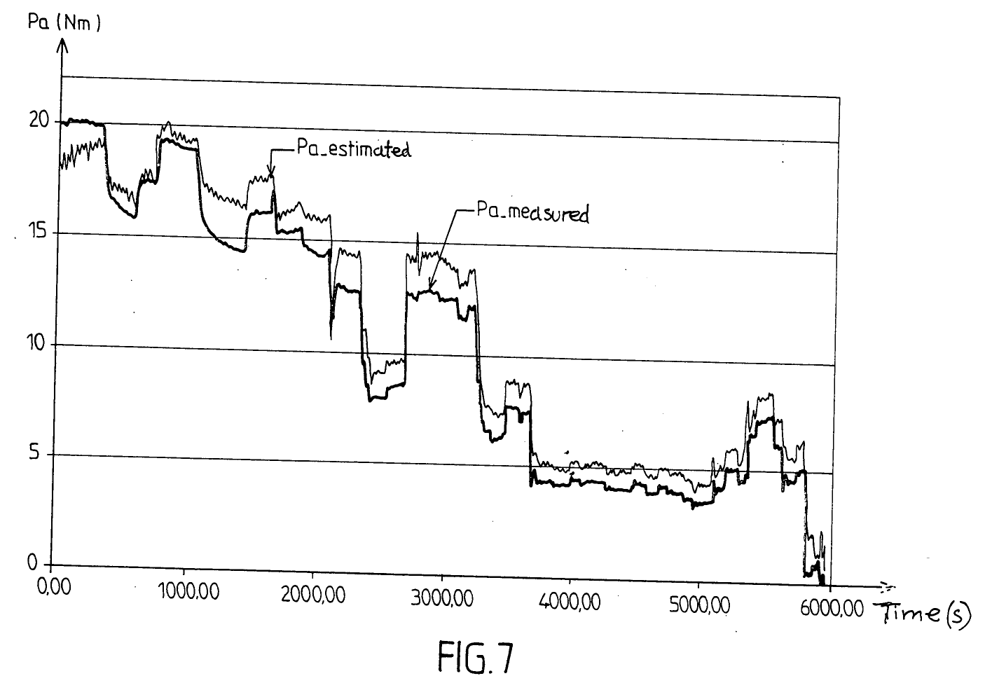

FIG. 7 illustrates the accuracy of the estimation made according to the invention, and

FIG. 8 represents the incorporation of a sensor in the evaporator. Annexe A comprises the main mathematical equations used for putting the installation into practice.

The drawings contain essentially elements the natures of which are definite. They will accordingly not only be able to serve to give a better understanding of the description, but also to contribute to the definition of the invention as appropriate.

Reference is first made to FIG. 1, which shows one example of an assembly of an air conditioning apparatus incorporated in a vehicle. The air conditioning apparatus comprises a closed circuit of refrigerant fluid. The air conditioning apparatus also includes a compressor 14, a cooling unit 11, an expansion unit 12 and an evaporator 13, through which the refrigerant fluid flows in that order. The circuit may also include an accumulator 17 which is located between the outlet of the evaporator and the inlet of the compressor, so as to prevent liquid surges.

The cooling unit 11 receives a flow of air 16 from outside for evacuating the heat drawn from within the cabin, which, under certain working conditions, is put in motion by a motorised fan unit 15.

The evaporator 113 receives a stream of air from a blower 20 which is supplied with a stream of fresh air 18, and produces a stream of conditioned air 21 which is delivered into the cabin of the vehicle.

FIG. 2a shows the installation according to the present invention, installed in a motor vehicle, which may be in motion at a forward speed Va. The motor vehicle is driven by an engine 43 which is controlled by an injection computer 42. The computer receives, from various sensors, information which it interprets in order to adjust the relevant parameters. Accordingly, it is able to supply data 33 about instantaneous values relating to the operation of the vehicle, and in particular the forward speed of the vehicle, the velocity of rotation of the compressor, and the voltage of the motorised fan unit.

The vehicle is also equipped with the air conditioning apparatus 10 described above, which is shown diagrammatically in FIG. 2a. In addition, the installation includes a cabin regulator 41 which is adapted for setting the demand for temperature of the outside air 18 which is blown to the inlet of the apparatus 13.

The injection computer of the engine is able to act on the air conditioning apparatus by virtue of an air conditioning regulator 402. This connection only enables starting or stopping of the air conditioning apparatus to be controlled in accordance with the conditions linked to the operation of the engine or with commands from outside. For example, it enables starting of the air conditioning apparatus to be forbidden when the engine is being worked hard.

The connection 402 is limited to working on an “all or nothing” basis. In the absence of a device for instantaneously estimating the power absorbed by a mechanical compressor, the air conditioning regulator 402 is unable to adjust the operation of the air conditioning loop.

The Applicant has put in place such an apparatus when enables this operation to be improved, starting with input and output pressure and temperature conditions of the expansion unit.

For this purpose, the cabin regulator 41, the injection computer 42 of the engine and the air conditioning apparatus 10 are all connected to an electronic control device, which is for example an electronic printed circuit 401, for two-way information exchange.

The electronic printed circuit performs the resolution of equations which enable an estimation to be obtained for the power absorbed by the compressor. It is also capable of transmitting the data that result from that estimation to the injection computer, over the link 32.

The electronic printed circuit 401 may be considered as an integral part of the air conditioning regulator 402. In particular, the air conditioning regulator 402 has the function of adapting the quantity of heat drawn from the cabin, known as the refrigerating power, so as to reach the demand for blown air at the output of the evaporator. This demand figure is indicated beforehand to the air conditioning regulator 402 by the cabin regulator (over the link 35).

The electronic printed circuit 401 recovers data 30 coming from sensors which are located on the air conditioning apparatus. It also receives data from the injection computer 42 of the engine over the link 33, in particular the forward speed of the vehicle, the voltage of the motorised fan unit, the velocity of rotation of the compressor, and the temperature of the outside air.

The cabin regulator 41 exchanges with the air conditioning regulator information relating to the demand for blown air at the outlet of the evaporator, over the links 34 and 35.

Mass flow of the refrigerant fluid, expanded on passing through an expansion device, is of the form:
MOT=f(Tin, Pin, Pout) (1),
where Tin is the temperature at the inlet of the expansion unit, and Pin, Pout are the pressures at the inlet and outlet of the expansion unit respectively, Pin being on the high pressure side and Pout on the low pressure side of the air conditioning circuit.

The power absorbed by the compressor may then be calculated from the estimation of the mass flow of refrigerant fluid expanded in the expansion unit in accordance with equation (1) and from the aspiration temperature of the compressor.

The electronic printed circuit is programmed in such a way as to carry out, beforehand, the resolution of the equation which supplies the value of the flow rate MOT (equation 1), from the working characteristics of the expansion unit (Tin, Pin, Pout). The electronic circuit board is also so programmed as to estimate the characteristics Tin, Pin, Pout.

The links 30, 33 and 35 between the electronic printed circuit 401 and the air conditioning apparatus 10, the injection computer 42 of the engine, and the cabin regulator 41 enable these estimations to be carried out.

In a first embodiment, a sub-critical refrigerant fluid passes through the air conditioning circuit, that is to say a fluid having a critical pressure that is greater than the pressure of the hot source, and the circuit comprises an expansion unit 12 of the calibrated orifice type, together with a cooling unit of the condenser type 11. In particular, the description will be given with respect to the refrigerant fluid R134a, by way of non-limiting example.

FIG. 4 describes the various steps which enable the mass flow of expanded fluid to be estimated, followed by the estimation of the power absorbed by the compressor, in one particular embodiment.

At step 100, the air conditioning installation carries out an estimation of Pin. Preferably, the air conditioning circuit includes a sensor 22, shown in FIG. 2a, for measuring Pin and for transmitting this value to the electronic printed circuit 401 over the link 30.

In steps 104 and 106, the electronic printed circuit 401 performs an initial estimation of the pressure Pout.

In one advantageous version shown in FIG. 4, this value is estimated through the aspiration pressure Ps of the compressor, making use of the characteristics of the compressor.

To that end, the electronic printed circuit contains pre-recorded values in table form, which constitute the regulation curve for the compressor. FIG. 5 shows such a curve for a compressor with external control. For a compressor with external control, the aspiration pressure of the compressor is linked to Is and Pin, where Is corresponds to the current intensity in the control valve of the compressor. The table then has two inputs Is and Pin. Knowledge of these two values enables the electronic circuit to provide a first estimate for the value of Ps (step 104).

Where the compressor has internal control or has a fixed outlet, the table only includes the input Pin. The aspiration pressure of the compressor is then estimated as a function of Pin only (step 106). Ps is in general close to 3 bars.

In both cases, the electronic printed circuit 401 receives the input value Pin from the sensor 22, shown in FIG. 2a, via the link 30. In the case of a compressor with external control, the electronic printed circuit 401 receives the current intensity Is over the link 33 from the injection computer of the engine.

In addition, in both cases, estimation of Ps from the regulation curve of the compressor depends only slightly on the value of Pin.

However, this first estimate of the aspiration pressure of the compressor is in error when the compressor is on full load. At full load, the aspiration pressure of the compressor is greater than the value obtained from the regulation curve of the compressor, or from Pin. The invention enables it to be determined whether the compressor is at full load, and if necessary to correct the error in the estimate of the aspiration pressure Ps. This correction is partly the object of steps 108 to 116.

Step 108 provides an estimate for the temperature Tin at the inlet of the expansion unit. This temperature may be supplied to the electronic printed circuit 401 by a sensor which is located at the inlet of the calibrated orifice. This sensor, which is shown in FIG. 2b, can be a temperature and pressure sensor for measuring Pin and Tin at the same time.

In a modified version, the temperature Tin may be estimated by the electronic printed circuit 401, from the under-cooling of the air conditioning circuit. FIG. 3 describes the operation of a condenser for an air conditioning circuit working with the fluid R134a. At A, the vapours superheated by the compressor enter into the condenser, and are de-superheated so that they reach the condensation temperature. At the point B, the first drop of liquid appears, indicating the start of condensation. The change of state continues between point B and point C, at constant temperature while the liquid phase becomes bigger and bigger.

Condensation finishes at D, when there are no further drops of liquid. The under-cooling of the liquid begins, and is continued up to the point E at the inlet of the calibrated orifice for reducing the temperature of the liquid. The under-cooling Sr of the fluid therefore corresponds to the difference between the condensation temperature Tk of the fluid at the point B and the temperature (Tin) at the point E at the inlet of the calibrated orifice.
Sr=Tk−Tin (3)
The first embodiment makes use of the under-cooling Sr of the liquid for estimating the mass flow MOT of the expanded fluid. This under-cooling feature is characteristic of sub-critical fluids. The value of the condensation temperature is linked to the pressure Pin, in conformity with the law of saturation of fluids. The electronic circuit 401 can then calculate the value of the condensation temperature Tk from the value of Pin supplied by the sensor 22.

In addition, the under-cooling Sr is a function of the forward speed of travel of the vehicle Va, the voltage GMV of the motorised fan unit, and the outside air temperature (Text). In a first embodiment, the electronic circuit (401 ) is therefore able to determine the temperature Tin from the value of Pin supplied by the sensor 22 and transmitted over the link 30, and from the values of the forward speed of travel of the vehicle Va, the voltage GMV of the motorised fan unit and the temperature of the outside air (Text) supplied by the injection computer 42 of the engine over the link 32.

In step 108, the electronic circuit also makes use of equation (1) to estimate the mass flow MOT of the fluid which is expanded by the calibrated orifice, from the values of Pin, Pout and Tin obtained as described above.

Annexe A1 shows an example of equation (1) used to calculate MOT. The coefficient a is a constant which takes into account the increase in the flow rate of refrigerant fluid with respect to the increase in the under-cooling at the inlet of the expansion unit. Coefficient b is a geometric characteristic of the calibrated orifice. pO is the volumetric mass of the fluid calculated from Tin.

In parallel with the above, in step 112 the electronic circuit 401 calculates an estimate of the volumetric flow rate Rv of the compressor. As indicated by the equations in annexe A2.1 and A2.2, the flow rate Rv is a function of the compression ratio τand the rotational velocity N of the compressor. The compression ratio corresponds to the ratio between the high pressure and the low pressure, and can therefore be calculated from the pressures Pin and Ps. The electronic circuit 401 accordingly calculates an estimate of Rv from the values of the pressure Pin and pressure Ps which are estimated as already described above, and from the value of the rotational velocity N supplied by the injection computer (over the link 33).

The object of making the calculation Rv is to estimate the mass flow mcpr of the refrigerant fluid aspirated at full power by the compressor, which is done in step 113.

From the values of the mass flow MOT of the fluid expanded by the calibrated orifice, obtained in step 110,and of the mass flow mcpr of the refrigerant fluid aspirated at full power by the compressor, obtained in step 113, the electronic circuit 401 performs a comparison between these two values in step 114, so as to determine whether the compressor is at full power and, if necessary, making a correction of the value of Ps.

A flow rate MOT lower than the flow rate mcpr signifies that the compressor is on reduced power. The value of Ps obtained in step 104 or 106 therefore remains valid.

A mass flow MOT close to the value of mass flow mcpr, by ±30 kg/h, signifies that the compressor is at the limit of its full power, but respects the regulation curve of the compressor. The initial value of Ps is still valid.

Where the mass flow MOT is greater than the mass flow mcpr, the compressor is at full power and the aspiration pressure has been under-estimated. It is therefore necessary to correct the value Ps estimated in the step 104 or 106. Thus, when the electronic circuit 401 detects a value of the flow rate MOT greater than the value of mcpr, it corrects, in step 116, the value of Ps by a factor of correction which corresponds to the ratio between the mass flow MOT and the mass flow mcpr, as is indicated in annexe A3.

In steps 120 and 122, the electronic circuit estimates the value of the aspiration temperature Ts of the compressor from Pout. In the first embodiment, the value of Pout corresponds to the value Ps which is obtained in one of the steps 104, 106 and 116.

The value of Ts is featured in the calculation of power absorbed by the compressor Pa.

More precisely, the Applicant makes use of the estimate of mass flow MOT of expanded refrigerant fluid, in order to calculate the mechanical power which is absorbed by the compressor. The estimation of the mass flow MOT depends only on conditions of temperature and pressure at the inlet and outlet of the calibrated orifice, and therefore gives good accuracy.

The apparatus described above is arranged to obtain data which, in accordance with the equations in annexe A4, enable the mechanical power absorbed to be calculated (see annexe A4.1). Apart from the mass flow of the expanded fluid, this data concerns the estimation of the isentropic compression work done, Wis (see annexe A4.1) and the velocity of rotation of the compressor N. The constants B, C and D are linked to operating parameters of the air conditioning circuit, and are therefore fixed as computation parameters.

In step 124, the electronic circuit 401 estimates the compression ratio Pr from the values of the pressure Pin and pressure Pout, in order to work out the isentropic compression work Wis. The isentropic compression work Wis is also calculated from the value of Ts estimated in step 120 or 122.

Pin and Pout are obtained during the foregoing estimations. In addition, the rotational velocity of the compressor N is supplied to the electronic circuit by the injection computer 42 of the engine, over the link 33, with reference to FIG. 2a.

FIG. 7 illustrates the accuracy of measurement of mechanical power in this embodiment, for an outside air temperature of 35° C., a velocity of rotation of 2000 rpm, and a blower in position 4. The graph shows that the spacing between the curve which represents estimated mechanical power absorbed by the compressor (Pa estimated), and the curve which represents measured mechanical power as absorbed by the compressor (Pa measured) is not great, which indicates satisfactory accuracy.

The computer 42 then addresses the injection module of the engine with the estimated value of the mechanical power absorbed by the compressor. The computer then adapts the nominal mechanical power absorbed by the compressor if the latter exceeds a maximum value defined by the computer from the said estimated value. As a result, fuel consumption is reduced and the excessive increases in power absorbed by the compressor are better controlled.

In the case of mechanical compressors with internal control, this estimated power is used to disconnect the compressor in order to reduce the mass flow of refrigerant fluid absorbed by the compressor.

In a second embodiment according to the invention, a supercritical refrigerant fluid flows through the air conditioning circuit, which has an internal heat exchanger 23 and an expansion unit 12 of the electric valve type. For supercritical fluids, the high pressure at high temperature is greater than the critical pressure of the fluid.

In this embodiment, the cooling unit 11 is an external cooler or gas cooler. In particular, the following description will be given with reference to the refrigerant fluid CO₂, by way of non-limiting example. An air conditioning circuit of this kind is shown in FIG. 6.

In air conditioning circuits which make use of such fluids, cooling of the fluid after compression does not involve any phase change. The fluid passes to the liquid state only during expansion. The internal heat exchanger 23 enables the fluid leaving the external cooler 11 to be cooled very severely, or even liquefied.

In step 100, the pressure Pin is measured as in the first embodiment, by a sensor.

At step 108 in FIG. 4, the temperature Tin may also be measured as indicated for the first embodiment, for example by the temperature and pressure sensor 122 shown in FIG. 2d. This sensor may accordingly provide the values of Pin and Tin simultaneously.

The CO₂ fluid does not therefore undergo any under-cooling. An estimation of Tin from Sr is accordingly no longer possible. In an air conditioning circuit which operates with CO₂, the temperature Tin at the inlet of the expansion unit is linked to the evaporation temperature Tev of the circuit, the temperature at the outlet of the external cooler 11, Tgcout, and the thermal efficiency of the internal thermal heat exchanger 23.

In particular, the temperature Tev may be measured by a sensor, designated by the reference 24 in FIG. 2c, which measures the evaporation temperature. This sensor, which may be a thermal resistance sensor of conventional construction, is located between the fins of the evaporator. FIG. 8 shows such a sensor 24.

In another version, the temperature Tev may be estimated from the temperature of blown air at the outlet of the evaporator, Tblown, which is supplied by the cabin regulator 11.

Tgcout may be measured by a temperature sensor 26 located at the outlet of the external cooler 11, as indicated in FIGS. 2c and 2d.

Since the air conditioning circuit includes an internal heat exchanger, the temperature Ts is estimated in step 120 from Pout, the evaporation temperature Tev, and the temperature Tgcout at the outlet of the external cooler (see annexe A6).

As in the first embodiment, Pout can be estimated by the aspiration pressure of the compressor Ps. The steps of estimating and correction of Ps in steps 108 to 116 apply in the identical way.

FIG. 2d corresponds to a modified version of the second embodiment, in which the air conditioning circuit includes the sensor 122 for measuring Pin and Tin, and the sensor 26 for measuring Tgcout, the evaporation temperature Tev being estimated from the blown air temperature Tblown, while Pout is estimated from the estimate of the aspiration pressure Ps.

The model for estimation of mechanical power in annexe A4 remains valid in the second embodiment.

In a first modified version in accordance with the two embodiments, the pressure Pout can be measured directly by a sensor 28 shown in FIG. 2a. This sensor may be placed in any desired position between the evaporator and the compressor. Its measurement is transmitted to the electronic circuit 401 over the link 30.

In a second modified version in accordance with the two embodiments, the value of the pressure Pout can be estimated directly from the estimation of the evaporation temperature Tev. The estimation of this temperature has been described above for the second embodiment. The electronic circuit 401 then estimates Pout by applying the law of saturation of fluids.

In the second embodiment, the evaporation temperature Tev may be estimated in order to calculate Tin and to calculate Ts. It is therefore of particular advantage to estimate Pout as a function of Tev for the second embodiment.

Annexe A5 comprises an example of an equation linking Tin, Pin and Pout in accordance with equation (1). The function k is a characteristic which defines the opening of the electrical valve 12 as a function of the current Iv applied to the valve. Iv is furnished by the air conditioning regulator 402. pO is the density of the fluid at the inlet of the electrical valve, and is estimated from Tin and from Pin.

The present invention also postulates the logic code which it employs, more particularly when it is disposed on any support which is readable by a computer. The expression “support readable by a computer” covers a storage support or memory, which may for example be magnetic or optical, as well as a transmission means such as a digital or analogue signal.

Annexe A

A1 Mass Flow of an Expanded Refrigerant Fluid in a Calibrated Orifice (MOT)
MOT=(1+a.Sr).b.√[ρO.(Pin−Pout)]
A2 Volumetric outDut Rv

A2.1—General Form of the Volumetric Output
Rv=f(τ, N)
τ=Pin/Pout

A2.2—Example of Volumetric Output
Rv=(C(N)−D(N))*τ
A3 Correction of the Aspiration Pressure Ps
Ps=Psinitial*(MOT/mcpr) if MOT>mcpr
A4 Power Pa Absorbed by the Compressor

A4.1 lsentropic Work Wis
Wis=C.Ts(Pr^{(n-D/n}−1)

A4.2 Power Absorbed by the Compressor
Pa=A.MOT.Wis+B.N

A5 Mass Flow of an Expanded Refrigerant Fluid in an Electrical Valve (MOT)
MOT=k(lv).√[ρO.(Pin−Pout)]
where pO is a function of Pin and Tin
A6 Aspiration Temperature Ts in a Supercritical Fluid Circuit
Ts=Hxi(Tgcout−Tev)+Tev
where Hxi is the thermal efficiency of the internal heat exchanger

1. An air conditioning installation for a motor vehicle having an injection computer (42) and an air conditioning regulator (402), the installation comprising a refrigerant circuit including a compressor (14), a cooling unit (11), an expansion unit (12) and an evaporator (13), together with an electronic control device (401) which is adapted to interact with the refrigerant fluid circuit (10), the injection computer (42) and the air conditioning regulator (402), characterised in that it includes measuring devices adapted to transmit values to the electronic control device for estimation of:
a first value relating to the temperature of the refrigerant fluid at the inlet of the expansion unit (Tin),
a second value relating to the pressure of the refrigerant fluid at the inlet of the expansion unit (Pin), and
a third value relating to the pressure of the refrigerant fluid at the outlet of the expansion unit (Pout),
and in that the electronic control device (401) is adapted to calculate the value of the mass flow (MOT) of the refrigerant fluid in the expansion unit from the estimation of the said first, second and third values, and to estimate, from the said value of the mass flow (MOT) of the refrigerant fluid in the expansion unit, and from the estimation of the third value (Pout), the power absorbed by the compressor (14).

2. An air conditioning installation according to claim 1, characterised in that the expansion unit is an orifice with a fixed cross section, and in that the cooling unit (11) is a condenser.

3. An air conditioning installation according to claim 1, characterised in that it includes an internal heat exchanger, and in that the expansion unit is an orifice of variable cross section and the refrigerant fluid is supercritical.

4. An air conditioning installation according to claim 3, characterised in that the expansion unit is an electrical valve, and in that the mass flow of the refrigerant fluid is further estimated from the value of the intensity (lv) of the current supplied to the electrical valve by the air conditioning regulator (402).

5. An air conditioning installation according to one of the preceding claims, characterised in that the first value is measured by a measuring means (122) located at the inlet of the expansion unit.

6. An air conditioning installation according to one of the preceding claims, characterised in that the second value is measured by a measuring means (22, 122) located at the inlet of the expansion unit.

7. An air conditioning installation according to claim 2, characterised in that the electronic control device is adapted to calculate an estimate of the first value from information relating to the operation of the vehicle transmitted by the injection computer (42), and from the second value (Pin).

8. An air conditioning installation according to claim 7, characterised in that the information relating to the operation of the vehicle consists of the forward speed (Va) of the vehicle, the voltage in the motorised fan unit (GMV) of the air conditioning circuit, and the temperature of the flow of air from outside (Text).

9. An air conditioning installation according to claim 3, characterised in that it includes a first measuring means (26) adapted to supply a value relating to the temperature at the outlet of the cooling unit (Tgcout).

10. An air conditioning installation according to one of the preceding claims, characterised in that it includes a second measuring means adapted to supply a value relating to the evaporation temperature (Tev).

11. An air conditioning installation according to claim 10, characterised in that the second measuring means is a sensor (24), which is located between the fins of the evaporator (13), and which provides a measurement of the instantaneous value of the evaporation temperature.

12. An air conditioning installation according to one of claims 1 to 9, characterised in that it includes a cabin regulator (41), and in that the electronic control device is adapted to estimate the value of the evaporation temperature (Tev) from the instantaneous value of the temperature (Tblown) of blown air at the outlet of the evaporator supplied by the cabin regulator (41).

13. An air conditioning installation according to claim 9 taken in combination with one of claims 10 to 12, characterised in that the electronic control device (401) is adapted to calculate an estimate of the first value from the values supplied by the first and second measuring means (Tgcout, Tev).

14. An air conditioning installation according to one of claims 10 to 12, characterised in that the electronic control device is adapted to estimate the third value (Pout) from the value supplied by the second measuring means (Tev).

15. An air conditioning installation according to one of claims 1 to 13, characterised in that the compressor is a compressor with external control, having a control valve, and in that the electronic control device is adapted to calculate a first estimate of the third value from previously registered values of the aspiration pressure (Ps) of the compressor, the second value (Pin) and the value of the intensity of current transmitted by the injection computer (42) to the control valve of the compressor.

16. An air conditioning installation according to one of claims 1 to 13, characterised in that the compressor is a compressor with internal control, and in that the electronic control device is adapted to calculate a first estimate of the third value from the previously entered values of the aspiration pressure (Ps) of the compressor, and from the second value.

17. An air conditioning installation according to one of claims 1 to 13, characterised in that the compressor is a fixed load compressor, and in that the electronic control device is adapted to calculate a first estimate of the third value from the values, previously entered, of the aspiration pressure (Ps) of the compressor, and from the second value.

18. An air conditioning installation according to one of claims 15 to 17, characterised in that the electronic control device is adapted to supply an estimate of the mass flow of the compressor at full power (mcpr) from the second and third values (Pin, Pout).

19. An air conditioning installation according to claim 18, characterised in that the electronic control device (401) is adapted to adjust the first estimate of the third value by comparing the estimated mass flow (MOT) of the refrigerant fluid into the expansion unit with the mass flow (mcpr) of the compressor at full power.

20. An air conditioning installation according to claim 19, characterised in that the electronic control device is adapted to adjust the first estimate of the third value by a correction factor, when the mass flow (MOT) of the refrigerant fluid into the expansion unit is greater than the mass flow (mcpr) of the compressor at full power.

21. An air conditioning installation according to claim 20, characterised in that the correction factor relates to the ratio between the mass flow (MOT) of the refrigerant fluid into the expansion unit and the mass flow (mcpr) of the compressor at full power.

22. An air conditioning installation according to one of claims 1 to 13, characterised in that the third value (Pout) is supplied by a measuring means (28) located at the inlet of the compressor.

23. An air conditioning installation according to claim 9, characterised in that the power (Pa) absorbed by the compressor is further estimated from the value relating to the temperature at the outlet of the cooling unit (Tgcout).
